(19) United States
(12) Patent Application Publication
(10) Pub. No.: US 2004/0153580 A1
(43) Pub. Date: Aug. 5, 2004

(54) Component based operation system dynamic device drive method

(76) Inventors: Rong Chen, Shanghai (CN); Yipeng Su, Shanghai (CN); Yongwen Du, Shanghai (CN); Kang Deng, Shanghai (CN)

Correspondence Address: RABIN & BERDO, P.C., Suite 500, 1101 14th Street, N.W., Washington, DC, 20005, US

(21) Appl. No.: 10/747,236

(22) Filed: Dec. 30, 2003

(30) Foreign Application Priority Data
Dec. 31, 2002 (CN) 02159471.6

(51) Int. Cl. G06F 3/00

(52) U.S. Cl. 710/1

(57) ABSTRACT

A component based operation system dynamic device drive method, in which the operation system manages all the device and drive component object via device manager, the customer program creates drive component object through device manager, the device manager communicates with drive component object, and the drive component object supplies application interface to customer program. In this invention, the drive program is realized in component-wise way and only when drive program is needed by application program, the drive program is loaded and drive component object is created; once drive component object application ended, the drive program would be deleted and downloaded from internal storage.

### FIELD OF THE INVENTION

The present invention relates to a component based operation system dynamic upload & download device drive method, especially relates to a device drive method, in which the drive program is realized in component-wise way and only when drive program is needed by application program, the drive program is loaded and drive component object is created; when drive component object application ended, the drive program be deleted and downloaded, so the CPU and internal storage resource are utilized reasonably and effectively, this invention is belong to the field of computer technology.

### BACKGROUND OF THE INVENTION

The management of device and its driving is a necessary function to any operation system. The operation system access the hardware device through drive program, making the knowing of concrete hardware access detail unnecessary to operation system by the isolation of drive program.

Meanwhile, device drives the interface as a system access hardware, its operation mode must be combined organically with the operation of operation system. In this way, the operation system is needed to conduct a necessary management and coordination to operation of device drive program, these management functions include:

1) Search for device information in hardware system. These device information may be obtained by the function detection in hardware itself, e.g. the device in PCI bus; or the device information may be added into system by way of manual setup.

2) Identify the device in system, by the device identifier, the device may be matched with the corresponding drive program. For example: in traditional Unix system, the device is identified by host device number and sub-device number and the corresponding drive program entry is found.

3) When the upper application needs to access hardware device, the operation system is responsible for making the correspond drive program active and supply the upper application with hardware access interface through drive program.

4) The operation system coordinates the operation of device drive program, manages the share hardware resource, detects and reports the resource conflicting and provides the device information service to device drive.

5) Finally, it is needed for operation system to provide necessary support means to the development of device drive program.

While the device management sub-system in traditional operation system provides the necessary function service above, it has the following 3 problems:

First, Non of the traditional operation system makes drive program in component-wise way. The drive program are fixed always with operation system, all the drive programs are loaded in operation system starting time regardless of customer needing this drive program or not; this caused waste both in CPU resource and internal storage resource.

Second, The drive programs run in core of operation system, however the operation which can run within core in traditional operation system is limited. For example, it couldn't access document system, can't access standard input-, output device, can't utilize more standard functions and system calling which may be utilized in customer state etc. These limitations bring about enormous inconvenient to the development of drive program, the drive programmers need to familiar with more development interfaces and programming stipulations which are different to the application development and the programming for drive program is hence difficulty.

Third, Owing to the limitation of over-address space, most drive program upper interfaces in traditional operation system are designed on basis of document interface. The developer of drive program couldn't define interfacing method of oneself according to device property.

### BRIEF DESCRIPTION OF THE INVENTON

The basic purpose of present invention is provide a component based operation system dynamic upload & download device drive method, except realizing the normal device and drive manage functions accomplished in traditional operation system, the drive program is realized in component-wise way and only when drive program is needed by application program, the drive program is loaded and drive component object is created; once drive component object application ended, the drive program would be deleted and downloaded from internal storage; so the CPU and internal storage resource are utilized reasonably and effectively.

The purpose of this invention is realized in following way:

A component based operation system device dynamic drive method, in which the operation system manages all the devices and drive component objects via device manager, the component customer program creates drive component object through device manager, the device manager communicates with drive component object, and the drive component object supplies application interface to component customer program.

The said device manager includes at least the followings:

Device enumerator interface, for supplying all the device information and its state information in system;

Device manager interface, for supplying function for creating device drive component object;

This device enumerator interface and device manager interface are provided to upper application;

Device information interface, provided to drive component object for drive component object obtaining its device information from them.

The said device manager obtains device information via system's device setup document and/or device enumerator interface, and transfers the corresponding device information to drive component object in form of device information interface parameter in time of drive component object initializing.

The said device manager collects and manages all the device information in manage system, creates the relative device node for each device and uniquely identifies every device in system according to the device identifier and device number.

The said drive component object includes at least the followings:

Drive interface, utilized for interaction between drive component object and device manager;

Application interface, utilized for accessing drive component object by application program.

The said drive component object includes further:

Device drive interrupt service routine interface, utilized for providing the entry of device drive interrupt service routine.

The concrete procedures of creating drive component object by device manager are:

Step 11: Utilize the standard function which is stipulated by COM specification and is for component object creation to create the drive component object;

Step 12: Fetch the device identifier from drive component object and find out the relative device node according to the device identifier;

Step 13: Create a new device node for drive component object in case of this device node no where to be found;

Step 14: Initialize the drive component object of device;

Step 15: Return to the drive component object interface.

Before drive component object creating, it includes further:

Step 10: Detect if the corresponding drive component object has been activated and the Step 11 is executed if no activated;

Step 10A: Detect further if the drive component object may be shared if has been activated;

Step 10B: Return back to the drive component object interface if may be shared, otherwise the creation is failed.

After device node is found, detect further if this device resource conflicts with the activated device and the Step 14 is executed in case of no conflicting, otherwise the creation is failed.

The said conflict detect is as follows: After the device information corresponding to drive component object is found, compare the device information of current created drive component object with one of which the drive component object has been created and it means conflict has occurred if the occupied device resource is same or partially same, otherwise it means no conflict occurred.

After initializing the device drive component object, it includes further:

Step 14A: Judge if the device node information has any interrupt number and execute Step 15 if no;

Step 14B: Inquire further the device drive interrupt service routine interface and the creation is failed if inquiry is failed;

Step 14C: Install the interrupt service routine program in case of inquiry is success and execute Step 15.

The method in present invention includes further: when the citing of drive component object is ended, the drive component object deletes itself; The concrete deletion including at least the followings:

Step 21; After drive component object citing is ended, minus 1 from the citing count value;

Step 22: Judge if this citing count value is zero, do not delete the drive component object and execute Step 26 if it is not zero;

Step 23: Inquire if this drive component object may be deleted at once, and repeating this Step after waiting a period of preset time if cannot be deleted;

Step 24: Cancel the drive component object;

Step 25: Delete the drive component object;

Step 26: Return back to count value citing.

In case of the drive component object is set to normal resident state, the corresponding normal resident drive component object is not deleted after citation and the concrete procedures are:

Set the drive component object to non-active state in case of the citation count value of normal resident drive component object is zero; when the component customer re-create the same drive component object in next time, return back directly to the interface of being exist drive component object and set the state of the drive component object to activated state.

A component based operation system device dynamic drive realized method, in which the drive component is defined by at least the following way:

Through announcing drive component, making the corresponding drive component to include at least the interactive interface provided from device drive component to device manager.

The interactive interface provided from said device drive component to device manager includes at least the followings:

Function of obtaining device identifier, utilized for returning the identifier of device driven by the drive object and to match the device manager with the corresponding device node;

Function of drive object initialization, for drive object obtaining its device information by the transferred device information interface parameter;

Sharing function, for indicating if the drive object supports the multi-line and multi-course;

Immediately download function, for decide according to the task accomplishment condition if exit at once when the drive object is to be download.

Make the drive component to include further the entry of device drive interrupt service routine in time of drive component announcement; the entry is automatically installed by at least the device manager and is called out when interrupt occurred.

The said drive component is realized by the following way: generate source program skeleton of the relative drive component in time of compilation according to the definition of drive component and realize all the corresponding functions by drive developer.

The said source program skeleton includes at least the upper application interface function defined by customer and the interactive interface function provided to device manager by device drive component. The said source program skeleton includes further the entry of device drive interrupt service routine.

Except realizing the normal device and drive manage functions accomplished in traditional operation system, the drive program is realized in component-wise way and only when drive program is needed by application program, the drive program is loaded and drive component object is created; once drive component object application ended, the drive program would be deleted and downloaded from internal storage; So the CPU and internal storage resource are utilized reasonably and effectively. Meanwhile, the drive program running in core of operation system is no more limited by the core of operation system, the developments for drive component and general application component have no difference in applicable system calling and API, so the development limitations for drive program is reduced; owning to the fact that drive component is no limited by the over-address space and the customer interface may be defined by oneself, developer of drive program could define the interfacing method of oneself according to device property.

### BRIEF DESCRIPTION OF THE APPENDED DRAWINGS

FIG. 1 is a principle illustrative view showing the general construction relationship in this invention.

FIG. 2 is a flowchart showing the drive component object creating in the present invention embodiment.

FIG. 3 is a flowchart showing the drive component object deletion in the present invention embodiment.

### DETAILED DESCRIPTION OF THE INVENTION

Next, a further description will be made as to the present invention with the Figures and concrete embodiment:

In present invention, the operation system may manage all devices and corresponding drive component objects in operation system by device manager (DeviceManager). The device drive model in this operation system makes component -wise device manager as core and realized on basis of following principle:

First, the device manager collects and manages all device information in operation system, creates a device node for each device and uniquely identifies these devices according to the device identifier and device number.

Then, regard the drive component object as a device attribute, only when the drive component object of corresponding device node is created, the device node becomes a activated device or active device.

The device manager creates the drive component object and matches device node and drive component object with device identifier and device number.

The interfaces realized by drive component above are divided into 2 groups: System interface, which is a standard interface defined by system and called by operation system; Upper customer interface, which is defined by drive component developer and called by customer program of drive component object.

Device manager manages the creation and wither away of drive component object, but does not take part in the application of drive component.

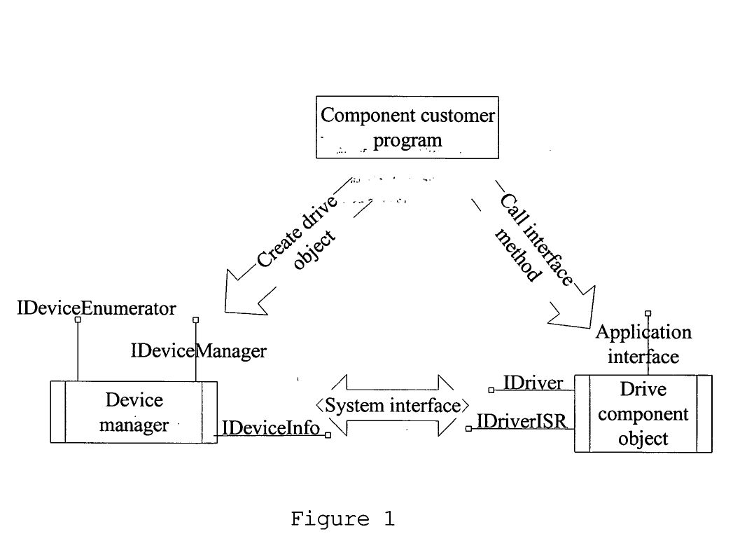

Refer to FIG. 1, which is a illustrative view showing the relationship for realizing device drive between component-wise device manager, drive component object and component customer program.

In which, drive component object realizes 2 standard system interfaces: i.e. device drive interface IDriver and device drive interrupt service routine interface IDriverISR (selectable), these two interfaces couldn't be seen from upper component customer program and utilized by device manager only.

Device manager supply device information interface IDeviceInfo for drive component object and the drive component object may obtain its device information from the device information interface.

Device manager supply further device enumerator interface IDeviceEnumerator and device manage interface IDeviceManager for upper application. Device enumerator interface IDeviceEnumerator enumerates all the device information and its states in system; Component customer program creates device drive component object with creation drive function (CreateDriver) within device manage interface IDeviceManager.

In order to make drive component object to run in correct device, all the devices within operation system must have a unique identifier of whole system. The device identifier mark (DeviceID) and device number (DeviceNo) are utilized for device identifying in the present invention.

Among which, device identifier mark has a character string form and different types of device may be divided out with it; e.g. device identifier mark for serial port is “COM” and device identifier mark for IDE controller is “IDE”. The device number has a number form for identifying the more same devices within system, the numbers are usually start from “1”. e.g. the device number of first serial port is 1, the device number of second serial port is 2 and so on.

It is different to the general component in: the corresponding key word must be utilized in attribute column of drive component, e.g. “driver”, which announces that this is a drive component. With key word “driver”, the drive component object includes 2 implicit standard system interfaces: i.e. device drive interface IDriver and device drive interrupt service routine interface IDriverISR, this means the programmer of drive component must realize these two interfaces.

Device drive interface IDriver is a interactive interface supplied to device manager from device drive component and device drive interrupt service routine interface IDriverISR is a entry for device drive interrupt service routine.

For device drive to which the interrupt service routine is needless, the key word “noisr” may be utilized to announce the drive component, in this way, the device drive interrupt service routine interface IDriverISR may not be included into component by compiler when driving the component from compile device.

The interrupt service routine function in device drive interrupt service routine interface IDriverISR is as a entry of interrupt service routine of driving and is installed automatically by device manager and is called out when interrupt occurred.

A drive component object may be example-wised by using drive component intellectual pointer by application of customer terminal program of drive component. Device number may be assigned before that (default value is 1).

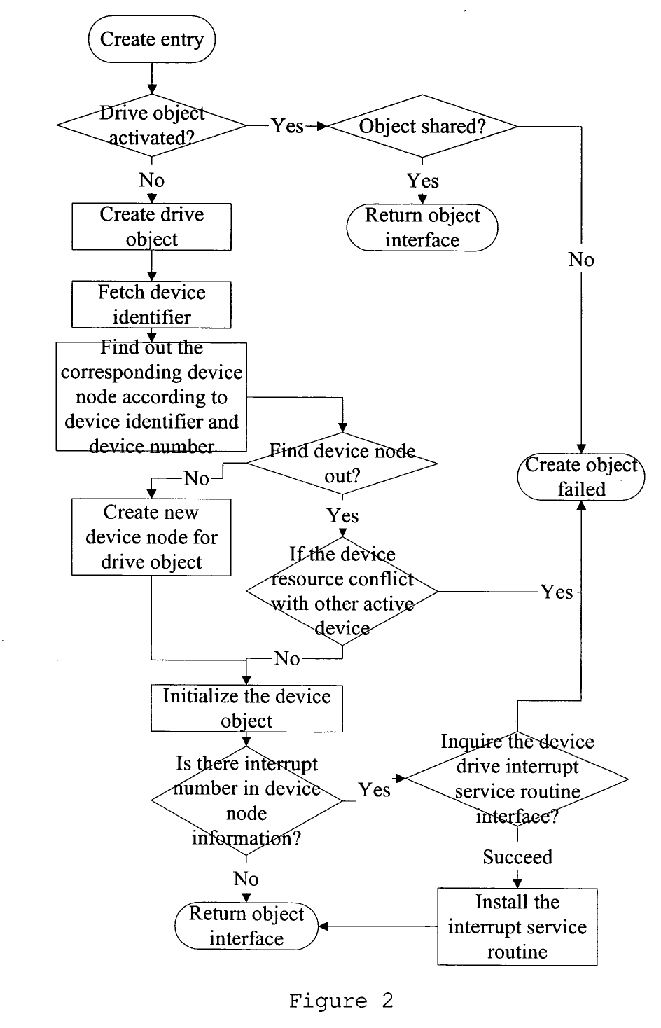

Refer to FIG. 2, the course of drive component object creating by device manager includes:

Step 10: Detect if the corresponding drive component object has been activated and the Step 11 is executed if no activated;

Step 10A: Detect further if the drive component object may be shared if has been activated;

Step 10B: Return back to the drive component object interface if may be shared, otherwise the creation is failed.

Step 11; Utilize the standard function which is stipulated by COM specification and for component object creation to create the drive component object;

Step 12: Read out the device identifier and find out the corresponding device node according to device identifier; after the device node is found, detect further if the device resource conflicts with the active device and execute Step 14 if do no conflict; otherwise the creation is failed.

Step 13: Create a new device node for drive component object in case of this device node no where to be found;

Step 14: Initialize the drive component object of device;

Step 14A: Judge if the device node information has any interrupt number and execute Step 15 if hasn't;

Step 14B: Inquire further the device drive interrupt service routine interface and the creation is failed if the inquiry is failed;

Step 14C: Install the interrupt service routine program in case of inquiry is success.

Step 15: Return to the drive component object interface.

As the general component, once the drive component object is no more utilized by component customer and it has no place for citing to the drive component object in system, i.e. when the citation count value of drive component object turns to zero, the drive component object deletes itself from internal storage. The difference is that before the drive component object deletes itself, it decides first that if the drive component object could be deleted at once and informs to device manager, so the device manager may maintain and manage the device state correctly.

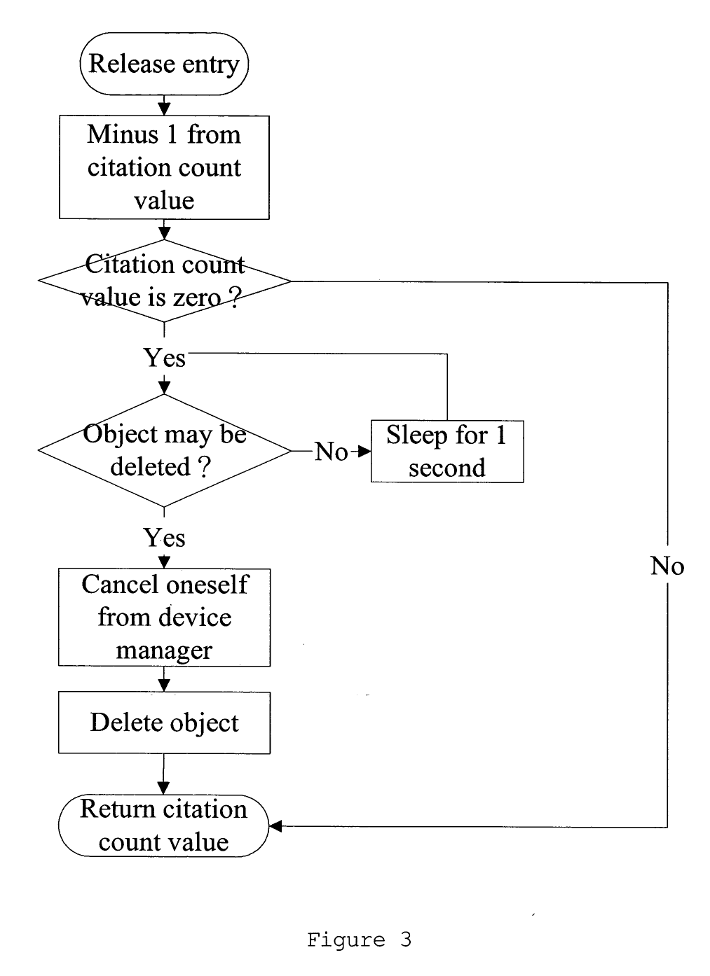

Refer to FIG. 3, the deletion of drive component object includes:

Step 21; After drive component object citation, minus 1 from the citing count value;

Step 22: Judge if this citing count value is zero, do not delete the drive component object and execute Step 26 if it is not zero;

Step 23: Inquire if this drive component object may be deleted at once, and repeating this step after waiting a period of preset time if cannot be deleted;

Step 24: Cancel the drive component object;

Step 25: Delete the drive component object;

Step 26: Return back to the citing count value.

In course of drive component object creation, after device information corresponding to drive component object is found, the device manager checks first if the resource occupied by this device conflicts with other device. The detecting content includes interrupt number, I/O address, internal storage image address and direct memory access (DMA) channel number etc.

In traditional operation system, such as Unix, Windows etc, the resource conflict detection is a static one, it compares the device resource with all other device resource in system and decides if conflicting occurs. Because the drive component object of operation system in present invention may be dynamically upload and download, so the method utilized by device manager for deciding if resources are conflicting is also a dynamic one, i.e.: in this method, the device information of new created current drive component object is compared with information of other active device (the device in which drive component object has been created).

The advantages of this dynamic resource conflicting detection are: some system hardware resources may be repeatable utilized. The same hardware resources may be utilized so long as the drive component of two device are not utilized at same time. E.g.: the acoustic card utilizes the direct memory access (DMA) channel 1 in system, the optic driver utilizes DMA channel 1 also, however resource conflicting wouldn't occur so long as the acoustic card and optic driver are not be utilized at same time.

When the device manager calls out the device drive interface IDriver and initializes the drive component object, a device information interface parameter would be transferred in. The drive component object obtains its device related information via the device information interface.

The important one to drive component developer is the hardware resource occupied by device, such as I/O address, internal storage address, DMA channel number etc. Because interrupt service routine program is installed automatically by device manager, so the interrupt number doesn't need to be care about in drive component realization.

For some devices, such as hard disk and network card etc, it is not hoped to create and delete frequently its drive component object to affect the operation system efficiency owning to its frequently utilization. In view of this, a regime which supports the normal resident drive program develop is needed. The resolutions in present invention are:

Announce the drive component is in a normal resident state in drive component defining, once the drive component is announced to be in normal resident state, this normal resident drive component object wouldn't deletes this drive component object really when the citation count is turn to zero. In practice, this drive component object informs device manager when the citation count value of normal resident drive component object is zero, and the device manager sets the drive component object to non-active state; When the component customer creates the same drive component object in next time, the device manager returns back directly the drive component object interface being exist and sets the state of the drive component object to a activated state.

The device manager collects device information through two ways in present invention: one is reading-in the device information from device setup document of operation system standard; other is obtaining device information through device enumerator driving. The device information so obtained are stored in form of chain table for retrieval. The corresponding device information is transferred to drive component object in form of device information interface parameter in case of calling the initialization function of drive component object.

As mentioned above, in time of device manager obtaining device information through device enumerator driving, the device enumerator interface enumerates all the device information in device enumerator and the corresponding device information is detected by the following functions: 1. Fetch the information of current device node; 2. Shift to next device node; 3. Resume to original state.

The typical device enumerator driving is the driving of every bus and controller. e.g. periphery unit extension interface (PCI) bus driving, all the device information automatically detected in PCI may be obtained through the enumerator interface. When device manager creates new device drive component object, it always detects if the drive component object supports device enumerator interface, if yes, all the device information in enumerator are taken out through the interface.

In embodiment of present invention, the drive component is realized through the following ways:

Defining a drive component, the difference between this drive component and traditional component is that the drive component must announce that this component is a drive component with corresponding key word( such as: driver). In fact, this announcement is for making drive component to include two implicit standard system interfaces: i.e. the interactive interface supplied to device manager from device drive component and the entry of device drive interrupt service routine.

For some device driving which don't need interrupt service routine program, the corresponding key word( e.g. noisr) may be utilized to announce that the drive component doesn't need interrupt service routine program, in this way, the entry of device drive interrupt service routine wouldn't be included into component when compiling the device drive component.

In above defined drive component, it should include at least the functions of device identifier obtaining, initializing, object sharing and immediately downloading etc; Among which: the device identifier obtaining function is for return the identifier of device driven by the drive object and the device manager makes match to the corresponding device node with it; The initializing is a first function called out after creating drive object and is for drive object initializing; The drive object may obtain self device information by the transferred-in device information interface parameter; The sharing function is for indicating if the drive object supports the multi-line or multi-course; The immediately download function is called out when the drive object is to be downloaded, this in fact provides a chance for drive object to decide if exit at once according to the task accomplishment condition.

The entry of device drive interrupt service routine includes interrupt service routine function, which is automatically installed by device manager as a driven interrupt service routine entry and is called out when interrupt occurring.

After drive component defining, the source program skeleton of drive component may be generated by running the specific compiler tool. In so created source program skeleton, except including the upper application interface function defined by customer self, it includes also all the functions within interactive interface provided to device manager by device drive component above and within entry interface of device drive interrupt service routine( if the customer doesn't specify the “noisr” attribute). The drive developer may realize all these functions by specified semantics.

In time of device manager calling the above initialization function to initialize the drive object, a device information(IdeviceInfo) interface parameter would be transferred-in The drive object may obtain its device relative information through IDeviceInfo. The important one to drive component developer is the hardware resource occupied by device, such as I/O address, internal storage address, DMA channel number etc. Because the interrupt service routine program is installed automatically by device manager, so the interrupt number doesn't need to be care about in realizing of drive component.

While the present invention has been particularly shown and described with references to preferred embodiments thereof, it is clearly understood that the same is by way of illustration and example only and is not to be taken by way of limitation, it will be understood by those skilled in the art that various variations, alterations, and modifications in form and details may be made therein without departing from the spirit and scope of the invention as defined by the claims and it intended to be encompassed in the scope of the present invention.

We claim:

1. A component based operation system device dynamic drive method, characterized in that the operation system manages all the devices and drive component objects via device manager, the component customer program creates drive component object through device manager, the device manager communicates with drive component object, and the drive component object supplies application interface to component customer program.

2. A component based operation system device dynamic drive method according to claim 1, characterized in that the said device manager includes at least the followings:
Device enumerator interface, for supplying all the device information and its state information in system;
Device manager interface, for supplying function for creating device drive component object;
This device enumerator interface and device manager interface are provided to upper application;
Device information interface, provided to drive component object for drive component object obtaining its device information from them.

3. A component based operation system device dynamic drive method according to claim 2, characterized in that the said device manager obtains device information via system's device setup document and/or device enumerator interface, and transfers the corresponding device information to drive component object in form of device information interface parameter in time of drive component object initializing.

4. A component based operation system device dynamic drive method according to claim 1, characterized in that the said device manager collects and manages all the device information in manage system, creates the relative device node for each device and uniquely identifies every device in system according to the device identifier and device number.

5. A component based operation system device dynamic drive method according to claim 1, characterized in that the said drive component object includes at least the followings:
Drive interface, utilized for interaction between drive component object and device manager;
Application interface, utilized for accessing drive component object by application program.

6. A component based operation system device dynamic drive method according to claim 5, characterized in that the said drive component object includes further:
Device drive interrupt service routine interface, utilized for providing the entry of device drive interrupt service routine.

7. A component based operation system device dynamic drive method according to claim 1, characterized in that the concrete procedures of creating drive component object by device manager are:
Step 11; Utilize the standard function which is stipulated by COM specification and is for component object creation to create the drive component object;
Step 12: Fetch the device identifier from drive component object and find out the relative device node according to the device identifier;
Step 13: Create a new device node for drive component object in case of this device node no where to be found;
Step 14: Initialize the drive component object of device;
Step 15: Return to the drive component object interface.

8. A component based operation system device dynamic drive method according to claim 7, characterized in that before drive component object creating, it includes further:
Step 10: Detect if the corresponding drive component object has been activated and the Step 11 is executed if no activated;
Step 10A: Detect further if the drive component object may be shared if has been activated;
Step 10B: Return back to the drive component object interface if may be shared, otherwise the creation is failed.

9. A component based operation system device dynamic drive method according to claim 7, characterized in that after device node is found, detect further if this device resource conflicts with the activated device and the Step 14 is executed in case of no conflicting, otherwise the creation is failed.

10. A component based operation system device dynamic drive method according to claim 9, characterized in that the said conflict detect is as follows: After the device information corresponding to drive component object is found, compare the device information of current created drive component object with one of which the drive component object has been created and it means conflict has occurred if the occupied device resource is same or partially same, otherwise it means no conflict occurred.

11. A component based operation system device dynamic drive method according to claim 7, characterized in that after initializing the device drive component object, it includes further:
Step 14A: Judge if the device node information has any interrupt number and execute Step 15 if no;
Step 14B: Inquire further the device drive interrupt service routine interface and the creation is failed if inquiry is failed;
Step 14C: Install the interrupt service routine program in case of inquiry is success and execute Step 15.

12. A component based operation system device dynamic drive method according to claim 1, characterized in that the method includes further: when the citing of drive component object is ended, the drive component object deletes itself; The concrete deletion including at least the followings:
Step21; After drive component object citing is ended, minus 1 from the citing count value;
Step 22: Judge if this citing count value is zero, do not delete the drive component object and execute Step 26 if it is not zero;
Step 23: Inquire if this drive component object may be deleted at once, and repeating this Step after waiting a period of preset time if cannot be deleted;
Step 24: Cancel the drive component object;
Step 25: Delete the drive component object;
Step 26: Return back to count value citing.

13. A component based operation system device dynamic drive method according to claim 12, characterized in that in case of the drive component object is set to normal resident state, the corresponding normal resident drive component object is not deleted after citation and the concrete procedures are:
Set the drive component object to non-active state in case of the citation count value of normal resident drive component object is zero; When the component customer re-create the same drive component object in next time, return back directly to the interface of being exist drive component object and set the state of the drive component object to activated state.

14. A component based operation system device dynamic drive realized method, characterized in that the drive component is defined by at least the following way:
Through announcing drive component, making the corresponding drive component to include at least the interactive interface provided from device drive component to device manager.

15. A component based operation system device dynamic drive realized method according to claim 14, characterized in that the interactive interface provided from said device drive component to device manager includes at least the followings:
Function of obtaining the device identifier, for returning the identifier of device driven by the drive object and to match the device manager with the corresponding device node;
Function of drive object initialization, for drive object obtaining its device information by the transferred device information interface parameter;
Sharing function, for indicating if the drive object supports the multi-line and multi-course;
Immediately download function, for decide according to the task accomplishment condition if exit at once when the drive object is to be download.

16. A component based operation system device dynamic drive realized method according to claim 14, characterized in that: Make the drive component to include further the entry of device drive interrupt service routine in time of drive component announcement; the entry is automatically installed by at least the device manager and is called out when interrupt occurred.

17. A component based operation system device dynamic drive realized method according to claim 14, characterized in that: the said drive component is realized by the following way: Generate source program skeleton of the relative drive component in time of compilation according to the definition of drive component and realize all the corresponding functions by drive developer.

18. A component based operation system device dynamic drive realized method according to claim 17, characterized in that: the said source program skeleton includes at least the upper application interface function defined by customer and the interactive interface function provided to device manager by device drive component.

19. A component based operation system device dynamic drive realized method according to claim 18, characterized in that: the said source program skeleton includes further the entry of device drive interrupt service routine.
